(19) United States
(12) Patent Application Publication
(10) Pub. No.: US 2019/0009447 A1
(43) Pub. Date: Jan. 10, 2019

(54) FILM PRODUCTION METHOD, FILM PRODUCTION ASSEMBLY, AND PLASTIC FILM

(71) Applicant: ADLER PELZER HOLDING GMBH, Witten (DE)

(72) Inventors: Norbert NICOLAI, Schermbeck-Gahlen (DE); André WUTZLER, Merseburg (DE); Volkmar SCHULZE, Schierling (DE); Hannes BLOMBERG, Witten (DE); Gabriele TOCCHI, Monza (IT)

(21) Appl. No.: 16/071,797

(22) PCT Filed: Feb. 3, 2016
(86) PCT No.: PCT/DE2016/100050

§ 371 Date: Jul. 20, 2018

(51) Int. Cl. B29C 47/00; B29C 37/00; B29C 47/14; B29C 43/46

(52) U.S. Cl. CPC B29C 47/004; B29C 47/0021; B29C 37/0025; B29L 2031/3017; B29C 43/46; B29K 2995/0021; B29C 47/14

(57) ABSTRACT

The invention relates to a film production method for producing a thermally deformable plastic film having an at least two-color design, comprising the following steps: extruding a first plastic to form a molten plastic melt and dispensing the plastic melt of the first plastic in a planar manner in a first thickness by means of an extruder nozzle/slit nozzle; applying a second, scatterable and/or free-flowing plastic in a defined, planar manner in a defined pattern design with a pattern template onto the plastic melt consisting of the first plastic, and calendaring/sizing the thickness of the plastic melt and simultaneously at least partially pressing the second plastic applied in a planar manner in the pattern design into the first plastic by means of a calendar assembly, cooling the melt to form a solid plastic film.

### FIELD OF THE INVENTION

The invention relates to a sheet production method for producing a thermally deformable plastic sheet having an at least two-color design.

Further, the invention relates to a sheet production assembly for producing a thermally deformable plastic sheet having an at least two-color design, and to a thermally deformable plastic sheet having an at least two-color design.

### BACKGROUND OF THE INVENTION

In commercial vehicles, the floor coverings are almost 100% of non-textile nature in the driver cabins. In the heavy trucks, these are made of rubber with only a few exceptions. In small or medium transporters and commercial vehicles, they are non-cross-linked plastic coverings with cover layers of PVC, and increasingly of TPO. The coverings essentially consist of a base color and are mostly printed with a defined design, and have another protective layer.

Because of the stress in daily use, the protective layer is destroyed at first, and the printed picture is increasingly abraded. At a mileage of from about 30,000 km, a printed decorative surface is usually no longer present in the region of the foot support area, depending on the degree of soiling and the footwear.

From the prior art, different floor coverings and floor covering production methods are known, by means of which structures can be created, in particular, that are partially or thoroughly colored through the bulk of the cover layer or the floor covering.

The printed document DE 35 46 151 C2 describes a process for preparing homogeneous flat articles with a design of different colors from a mixture of thermoplastic materials, preferably PVC. Granular materials having a maximum grain size of 2.5 mm are poured to form a layer, plasticized under the effect of heat until a porous continuous layer has formed. Optionally, after cooling, a liquid or free-flowing meltable colored medium is applied in predetermined patterns, which penetrates into the porous layer to the desired depth. Under pressure and heat, the colored porous layer is compacted to form a compact flat article.

Further, in printed document DE 44 45 429 C1, sharp-edged PVC granules are scattered onto a heated plastic film upstream of a first calendar, and pressed firmly in the rolls. After another heating of the film, a flat structure is produced on the film using an embossing roll in another calendar, and the contour of the granules is reduced in sharpness. In a subsequent belt press with a heated cylinder, the final pressing and welding of the granules with the film is effected. A floor covering with a sharp-edged non-directional marbling is formed.

The printed document DE 195 27 553 C1 describes a method in which homogeneous elastic floor covering plastic sheets or plates with a non-directional color pattern can be produced. A multicolored rod of granules is compacted into a plate or sheet. The rods of granules have colored regions in which 2 or more colors are essentially not mixed with one another. The colored regions mainly run in parallel with the longitudinal axis of the rods. When processed in a roll or calendar, a colored pattern without a preferential direction can be produced in one operation.

From printed documents DE 37 43 297 A1 and DE 37 43 296 A1, a process for producing homogeneous plastic sheets or plates having multicolored structures has been known, in which multicolored granules are processed together and shaped into sheets. The granules consist of an EVA binder as well as up to 80% by weight filler and 5% by weight color pigments.

The printed document DE 44 05 589 C1 describes a process for cross-linkable plastics or rubbers in which one-colored material strands or strands with lengthwise distributed colors are cut into disk granules, and these granules are applied to a material sheet of another color upstream of a first pair of calendar rolls. In a possible further step, another color can be applied as granules and incorporated into the material through a subsequent calendar. The disk granules can be incorporated only superficially from one or both sides. In a last step, the material sheet is cross-linked.

Further, in printed document DE 36 88 134 T2, an inlaid type of sheet material is produced in such a way that colored resin particles are applied into a non-gelled PVC plastisol, pressed into the sheet continuously with increasing pressure, and the plastisol is simultaneously gelled to form a thoroughly colored plastic sheet.

The printed document DE 25 52 653 C3 describes a process for producing resin layers with geometric decorative patterns in which resin particles having different colors are laid onto a support one after another using templates, and are subsequently sintered together by supplying heat.

Further, from printed document GB 1,087,560 A, a device or a process having two perforated rotating cylinders supplied with a powder is known. Every time when the perforations encounter, powder is applied onto the support, which is passed along below. It is particularly advantageous that the powder partially penetrates into the substrate because of the heat treatment, thus achieving a high stability.

The printed document FR 1.167.760 A describes a process in which two fractions of a material having different colors, preferably PVC, are compressed into a sheet using a calendar and pressed into a thermoplastic base material. This structure is heated at least to the melting temperature of the base material and compressed, wherein the granules are completely enclosed.

Generally, the structures described in the prior art can be described by a multilayer structure in which a plastic layer, mostly PVC sheet, is applied to a support, which is subsequently provided with a superficial decoration. Another transparent layer is often applied to the surface for protection. However, all these techniques are printing techniques in the broadest sense, in which viscous materials are employed.

The problems in the prior art essentially include the fact that it is not currently possible to prepare an inexpensive floor covering with a corresponding cover layer that meets the following requirements:
The cover layer and/or floor covering must be thermally deformable;
the cover layer and/or covering has a defined predetermined design with at least two colors; and
the cover layer and/or floor covering is thoroughly colored at least in part, especially at least 30%, to prevent superficial wear of the design.

In particular, it has been recognized that all these requirements cannot be met by any plastic sheets of the prior art.

### BRIEF SUMMARY OF THE INVENTION

It is the object of the present invention to provide a cost-effective and efficient sheet production method and a sheet production assembly and a plastic sheet that can be produced thereby, in which a predetermined design is realized, which design reaches at least partially or entirely through the bulk of the covering, so that the appearance of the covering is not changed by abrasion on the surface of the floor covering.

This object is achieved by a sheet production process according to the main claim, a sheet production assembly according to another independent claim, and further by a plastic sheet according to another independent claim.

The sheet production process disclosed herein for producing a thermally deformable plastic sheet having an at least two-color design includes at least the following steps:
extruding a first plastic material into a flowable plastic melt, and two-dimensionally dispensing the plastic melt of the first plastic material in a first thickness using an extruder assembly or extruder die;
applying a second scatterable and/or free-flowing plastic material in a defined two-dimensional way and in a defined pattern design using a pattern template to the plastic melt consisting of the first plastic material; and
calendaring/calibrating the plastic melt and simultaneously at least partially impressing the second plastic material applied two-dimensionally and in a pattern design into the first plastic material by means of a calendar assembly;
cooling the melt into a solid plastic sheet.

As possible plastic materials, olefin-based thermoplastic elastomers, TPO, TPE-O, urethane-based thermoplastic elastomers, TPU, TPE-U, PVC are more preferably employed, and also employed are all flexible thermoplastic materials, such as polyethylene, polypropylene, polyvinyl chloride, polyurethane as such and as a component of copolymers, and in mixtures, and unfilled as well as provided with an inorganic filler.

The second plastic material may be a first plastic material with a different color, which differs from the first plastic material only in color in a preferred embodiment, i.e., could be a first plastic material that has been colored differently.

Further, as the second plastic material, there may also be employed a material compatible with the first plastic material and having similar properties in the cold and heated states. “Compatible” as used herein means that the polymers are miscible at a molecular level.

In this respect, reference is made to D. R. Paul, S. Newman, Polymer Blends, Vol. 1 & 2, Academic Press Inc., London 1978, and M. J. Folkes, P. S. Hope, Polymer Blends and Alloys, Blackie Academic & Professional, London, Glasgow, New York 1993, and Manfred Rätzsch, Wechselwirkung zwischen Polymeren, in “Polymerreaktionen and reaktives Aufbereiten in kontinuierlichen Maschinen”, pp. 41-66, VDI Verlag Düsseldorf 1988.

A possible combination is a PP-based TPO as a first material with a homo- or CoPP as the second material. The same then applies to the other base polymers, such as PE, PU and PA.

The following Table shows the mutual compatibilities of different plastic materials:

TABLE 1
Mutual compatibility of thermoplasts and thermoplastic elastomers - Bayer AG, Kassel University, Gummiwerke Greiburg

| Mixing | Main component | | | | | | | | | | | | |
|---|---|---|---|---|---|---|---|---|---|---|---|---|---|
| component | ABS | ASA | EVAC | PA | PA 12 | PBT | PBT + PC | PC | PC + ABS | PC + PBT | PE − HD | PE − LD | PET |
| ABS | + | + | | ∘ | | + | + | + | + | + | ∘ | − | ∘ |
| ASA | + | + | | ∘ | | + | + | + | + | + | ∘ | − | ∘ |
| EVAC | | | + | | | | | | | | | + | |
| PA6 | ∘ | ∘ | | + | | ∘ | ∘ | − | − | − | ∘ | | ∘ |
| PA66 | ∘ | ∘ | | + | | ∘ | ∘ | − | − | − | ∘ | | ∘ |
| PA12 | | | | | + | | | | | | | | |
| PBT | + | + | | ∘ | | + | + | + | + | + | ∘ | | ∘ |
| PBT + PC | + | + | | ∘ | | + | + | + | + | + | ∘ | | ∘ |
| PC | + | + | | − | | + | + | + | + | + | ∘ | | + |
| PC + ABS | + | + | | ∘ | | + | + | + | + | + | ∘ | | + |
| PC + PBT | + | + | | − | | + | + | + | + | + | ∘ | | + |
| PE − HD | − | − | | ∘ | | − | − | − | − | − | + | + | − |
| PE − LD | − | − | | ∘ | | | | | | | | + | |
| PET | + | + | | ∘ | | + | + | + | + | + | ∘ | | + |
| PMMA | + | + | | ∘ | | ∘ | ∘ | + | + | + | ∘ | | ∘ |
| POM | ∘ | ∘ | | ∘ | | ∘ | ∘ | − | − | − | ∘ | | − |
| PP | − | − | | ∘ | | − | − | − | − | − | ∘ | | ∘ |
| PPE + SB | ∘ | ∘ | | + | | ∘ | ∘ | ∘ | ∘ | ∘ | ∘ | | ∘ |
| PS | ∘ | ∘ | | ∘ | + | ∘ | ∘ | ∘ | ∘ | ∘ | ∘ | | ∘ |
| PVC − U | + | + | | − | | − | − | − | − | − | ∘ | | − |
| SAN | + | + | | ∘ | | + | + | + | + | + | ∘ | | ∘ |
| TPA | − | − | | + | − | − | | − | | | | | − |
| TPE | − | − | | + | + | + | | − | | | | | + |
| TPO | − | − | | ∘+ | | − | | − | | | + | + | − |
| TPS | + | − | | +∘ | +∘ | − | | ∘− | | +∘ | − | + | − |
| TPU | + | + | − | + | + | +∘ | + | + | + | + | +∘ | − | + |
| TPE − X | | | | | + | | | | | | | | |

| Mixing | Main component | | | | | | | | | | | | |
|---|---|---|---|---|---|---|---|---|---|---|---|---|---|
| component | PMMA | POM | PP | PPE + SB | PS | PVC − U | SAN | TPA | TPE | TPO | TPS | TPU | TPE − X |
| ABS | + | ∘ | ∘ | ∘ | ∘ | + | + | − | − | − | + | + | |
| ASA | + | ∘ | ∘ | ∘ | ∘ | + | + | − | − | − | − | + | |
| EVAC | | | | | | + | | | | | | − | |
| PA6 | ∘ | ∘ | ∘ | ∘ | ∘ | − | ∘ | + | + | | +∘ | + | + |
| PA66 | ∘ | ∘ | ∘ | ∘ | ∘ | | ∘ | + | | | +∘ | | |
| PA12 | | | | | | | | | | | +∘ | | + |
| PBT | ∘ | ∘ | ∘ | ∘ | ∘ | − | + | | + | | + | ∘ | |
| PBT + PC | ∘ | − | ∘ | ∘ | ∘ | − | + | | | | + | + | |
| PC | + | − | ∘ | ∘ | ∘ | − | + | − | − | − | + | + | |
| PC + ABS | + | ∘ | ∘ | ∘ | ∘ | − | + | | | | ∘ | + | |
| PC + PBT | + | ∘ | ∘ | ∘ | ∘ | − | + | | | | + | + | |
| PE − HD | − | − | + | ∘ | − | ∘ | − | | | + | + | ∘− | |
| PE − LD | | | | | | | | | | + | + | − | |
| PET | ∘ | ∘ | ∘ | ∘ | ∘ | − | + | | | | | ∘ | |
| PMMA | + | − | ∘ | ∘ | ∘ | ∘ | + | | | | | ∘ | |
| POM | − | + | ∘ | ∘ | ∘ | ∘ | ∘ | − | + | ∘− | − | +∘ | |
| PP | − | ∘ | + | ∘ | − | − | − | − | − | + | + | ∘− | |
| PPE + SB | ∘ | ∘ | ∘ | + | + | − | ∘ | | | | + | ∘ | |
| PS | ∘ | ∘ | ∘ | + | + | ∘ | ∘ | − | − | − | + | − | |
| PVC − U | + | + | ∘ | ∘ | ∘ | + | + | − | − | − | − | + | |
| SAN | + | ∘ | ∘ | ∘ | ∘ | + | + | | | | + | ∘ | |
| TPA | | − | − | | − | − | | + | | | | | |
| TPE | | + | − | | − | − | | | + | | | | |
| TPO | | +∘ | + | | − | − | | | | + | | | |
| TPS | | − | + | | + | − | | | + | | + | | |
| TPU | +∘ | + | ∘− | ∘ | − | + | + | | | | | + | |
| TPE − X | | | | | | | | | | | | | + |

“+” = good,
“∘” = conditional to poor,
“−” no binding,
“ ” = no information available

The application of the second plastic material to the flat plastic melt consisting of the first plastic material may be effected by scattering. Corresponding scattering devices suggest themselves, for example, scattering means with all kinds of templates, especially round templates in the form of a rotary template scatterer, as known, for example, from the manufacturer Sandvik. Of course, other application methods with templates are also conceivable, wherein it is only necessary to connect these application methods in parallel with the feeding of the plastic melt during the process.

For applying the second plastic material, the second plastic material may be present as granules, as a powder, grit or mixture of particles, wherein the particle size of the second plastic material preferably corresponds to the final thickness of the plastic sheet, or is thicker by a maximum of 50% and/or thinner, for a minimum of 70%, than the final thickness of the plastic sheet. With these preferred particle sizes, the best appearance results of the later plastic sheet having a two-color design can be achieved. However, it is also possible already with smaller particles to achieve a plastic sheet having a two-color design, wherein the particles have penetrated from one side in accordance with their size only partially into the flowable plastic melt of the first plastic material, and thus a penetration depth of at least about 30% of the later thickness of the plastic sheet should be obtained. Therefore, it is recommended to limit the particle size at least to 30% of the later thickness of the plastic sheet as a lower limit, because the plastic sheet can be worn off in this way during its later use without the design disappearing immediately, for example, when the plastic sheet is employed as a floor covering.

The sheet production assembly for producing a thermally deformable plastic sheet having an at least two-color design, especially by a sheet production process as herein disclosed, includes:
an extruder with a slot die for producing and dispensing a flat flowable plastic melt of a first plastic material;
an application and/or scattering device for applying/scattering a second plastic material onto the plastic melt consisting of the first plastic material;
a calendar assembly for calibrating the thickness of the sheet and simultaneously at least partially impressing the second plastic material into the plastic melt consisting of the first plastic material;
   wherein
said application and/or scattering device is provided in the zone of the calendar assembly; and
the orientation of the plastic melt in the zone of said application and/or scattering device is horizontal.

It is possible thereby to realize a two-color design during the production process within a plastic sheet to be prepared, wherein said design is at least partially present within the bulk of the plastic sheet. It is just an inventive feature to apply or scatter the second plastic material, which is in the form of a powder, grit, granules or particles, for example, onto the first plastic material before the solidification and calendaring, so that the second plastic material can be impressed into the first plastic material during the calendaring, and melts together with the first plastic material to form a plastic sheet. In particular, the plastic sheet may also be formed in a materially homogeneous way.

The application and/or scattering device is a scattering device with a template or round template, and may preferably be equipped with a single or double doctor blade assembly.

In a preferred embodiment, the calendar assembly and the application and/or scattering device may be combined, wherein the application and/or scattering device is arranged above a first calendar roll, and second and third calendar rolls are provided in order to perform thickness calibration and cooling. It is particularly preferred if the first calendar roll has a larger diameter, so that enough place is provided for said application and/or scattering device.

In another embodiment, the melt can be placed on a transport belt and then supplied to a calendar.

The disclosed thermally deformable plastic sheet having an at least two-color design, especially if produced by a sheet production process and/or using a sheet production assembly as herein disclosed, includes a first plastic material with a first color and at least one second plastic material with a second color different from the first color, wherein said plastic materials are molten together, the second plastic material is incorporated in the sheet at least partially, and by more than 30% of the sheet thickness in the thickness dimension, and at least one surface side of the sheet has a defined design/pattern formed by said two-color design.

In a particularly preferred embodiment, said first and second plastic materials can be made of the same material and have different colors, wherein said first and second plastic materials may be selected from the materials:
olefin-based thermoplastic elastomers, TPO, TPE-O,
urethane-based thermoplastic elastomers, TPU, TPE-U, PVC,
all flexible thermoplastic materials, such as polyethylene, polypropylene, polyvinyl chloride, polyurethane as such and as a component of copolymers, and in mixtures, and unfilled as well as provided with an inorganic filler.

### BRIEF DESCRIPTION OF THE DRAWINGS

In the following, Examples of the invention are described in some detail using the enclosed drawings in the Description of the Figures, the latter being intended to illustrate the invention, and are not to be considered limiting:

FIG. 1 shows a schematic Example of the disclosed plastic sheet production assembly;

FIG. 2 shows a detailed side view of the scattering device within the disclosed plastic sheet production assembly according to FIG. 1;

FIG. 3 shows a schematic second Example of the disclosed plastic sheet production assembly; and

FIG. 4 shows a polished transverse section of a plastic sheet with a design produced by the disclosed process.

### DETAILED DESCRIPTION OF THE INVENTION

The plastic sheet production assembly includes an extruder 2 at the exit of which an extruder die 3 is provided, by means of which it is possible to extrude a first plastic material 12 into a flat flowable plastic melt 1.

Further, the plastic sheet production assembly includes a calendar assembly 5, 6, 7 that serves to calibrate the thickness of the plastic melt 1 or plastic sheet 1. In this preferred Example, the calendar assembly has three calendar rolls, i.e., a first one 5, a second one 6, and a third calendar roll 7. The second 5 and third 7 calendar rolls are arranged above one another, together forming a second calibrating stage. The first 5 and second 6 calendar rolls are arranged with a horizontal set-off, together forming a first calibrating stage.

A further particular feature in this Example is the fact that the first calendar roll 5 has a significantly larger diameter as compared to the subsequently arranged further calendar rolls 6 and 7, so that an application and/or scattering device 4 can be provided on the upper side of the first calendar roll 5 to create sufficient space for an additional process step, namely scattering.

In the extruder 2, the first plastic 12 is molten and extruded from the extruder die 3, and fed to the subsequently arranged calendar assembly 5, 6, 7. The calendar assembly 5, 6, 7 has such a design that the plastic melt 1 can be laid down horizontally on the first calendar roll 5 of the calendar.

A scattering device 4 with a round template 10 is provided as a part of the application and/or scattering device 4, wherein a rotary template scatterer 4 is used in this Example. Using this scattering device 4 with the round template 10, a second plastic material 8 is applied to said flowable plastic melt 1 having a defined design. The second plastic material 8 is preferably the same as the first plastic material 12, but with a different color, so that a two-color design is obtained.

The second plastic material 8 can be in the form of granules, a powder, grit or mixture of particles, so that it is scatterable or free flowing. Thus, a pattern can be applied to the first plastic material 12, whereby an at least two-color design is ultimately formed. The second plastic material 8 in the form of a scattering material preferably has particle sizes within the range of the later sheet thickness. Particular designs in which the coloring is larger than the particle size must be prepared from several particles, which is realized by a corresponding template. With smaller particles, a superficial penetration into the flowable plastic melt 1 is only possible, which results in only partial rather than complete coloring of the produced plastic sheet with the design 1′, however. In contrast, particles of the second plastic material 8 that are too large are deformed during a calibrating step to be performed subsequently, and could change the design adversely.

It may be noted here that it is also possible to achieve three- or four-color as well as multi-color designs by applying an additional third or further plastic materials, in which the scattering processes can be performed by means of one application and/or scattering device 4, but also by means of several ones arranged one behind another.

Further, a closed feeding tube 9 with an integrated conveying screw can be provided for embodying the application and/or scattering device 4, wherein the second plastic material 8 is transported axially into the round template 10. On the lower side of the feeding tube 9, there are adjustable outlet openings for the second plastic material 8, so that a defined uniform and continuous flow of material to a double doctor knife assembly 11 mounted on the bottom side can be ensured thereby. Said double doctor knife assembly 11 coats the second plastic material 8 from inside through the openings of the template 10, being precisely applied to the plastic melt 1 passing by below in accordance with the template pattern.

After the second plastic material 8 has been applied to the plastic melt 1 consisting of the first plastic material 12, a thickness calibration is performed through the calendar assembly 5, 6, 7 with the two further rolls 6 and 7, so that a defined plastic sheet 1 is formed. In these rolls 5, 6, 7, the second plastic material 8 scattered on in a powder form is virtually pressed into the plastic melt 1, melting together with this 1 to form a strong bonding between the first 12 and second 8 plastic materials. The plastic melt 1 provided with a differently colored powdered scattering material 8 is calendared to the desired thickness, wherein particles of the powdered scattering material 8 having dimensions larger than the sheet thickness are pressed to the sheet thickness and are not elongated, or only slightly so, depending on their size. Finally, the plastic melt 1 with the design is cooled down and drawn off as a plastic sheet 1′ with a design.

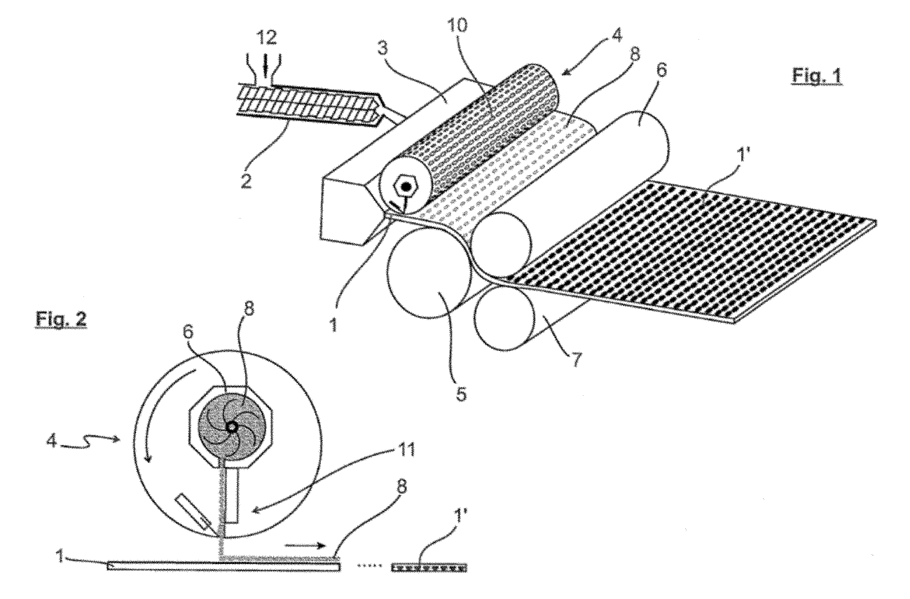

FIG. 2 shows a detailed side view of the scattering device within the disclosed plastic sheet production assembly according to FIG. 1.

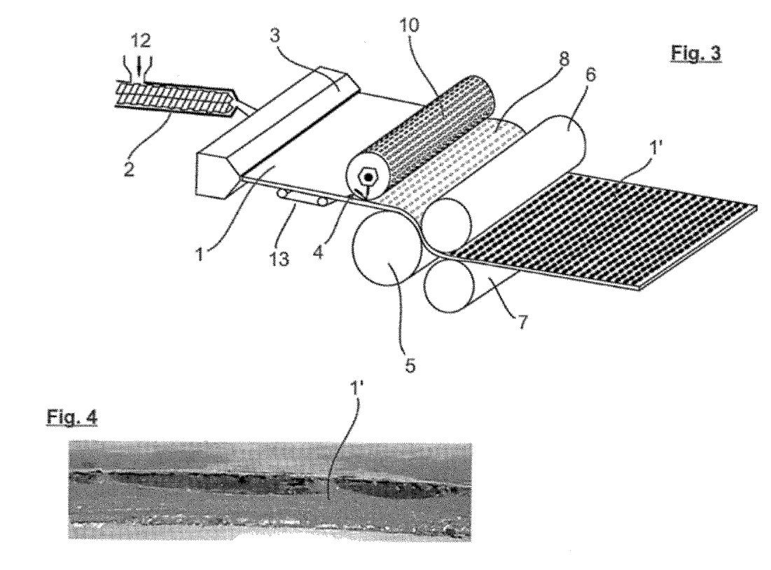

FIG. 3 shows a schematic second Example of the disclosed plastic sheet production assembly.

In this variant embodiment, a transport belt assembly 13 is arranged between the extruder die 3 designed as a slot die, on which the sheet is laid down at first after extruding and subsequently supplied to the scattering device 4.

FIG. 4 shows a polished transverse section of a plastic sheet with a design 1′ as produced by the disclosed process. The produced plastic sheet 1 consists of a first plastic material 12 and a second plastic material 8 applied through a defined pattern design, which are molten together and thus form the plastic sheet 1′ having a two-color design.

It is clearly seen that a sheet with a design having coloring until a certain depth was produced as the final product, so that this produced sheet is very resistant against abrasion, because the design was applied not only superficially.

The following is a description of the invention in a supplementary, but not limiting way by means of a concrete Example including the two Figures explained above:

An LLDPE-based TPO is used as the base material. The material has a light gray coloring and forms the first plastic material 12. The same material, but with a black coloring, is ground into a powder and thus forms the second plastic material 8. A sieve fraction with an average diameter of 0.8 mm is used.

Twenty-five percent of the total mass of the finished plastic sheet 1 is scattered thereon as a powder in the form of the second plastic material 8. Ovals having dimensions of 3 mm×6 mm in the main directions were selected as the design. The calendar gap is adjusted to a value of 0.45 mm. The draw-off speed of the sheet is 4 m/min.

The powder, i.e., the second plastic material 8, is not completely pressed into the base material, i.e., the first plastic material 12, so that some roughness is formed in contrast to the non-scattered surface, which results in a significant reduction of the slipping properties, ultimately bringing about considerable and obvious advantages when used, for example, as a floor covering for a vehicle.

The material was further processed into a floor covering for a vehicle, and in examination relating to abrasion, it could be found that the surface looks exactly as it did at the start after 1000 revolutions in a Taber test, while the printed patterns have lost their colors already after 500 revolutions.

### LIST OF REFERENCE SYMBOLS

1 plastic sheet/plastic melt

1′ plastic sheet with design

2 extruder

3 extruder die

4 scattering means

5 first calendar roll

6 second calendar roll

7 third calendar roll

8 second plastic material

9 feeding tube/supply

10 round template

11 doctor knife/double doctor knife

12 first plastic material

13 transport belt assembly

1. A sheet production process for producing a thermally deformable plastic sheet having an at least two-color design, comprising the steps:
extruding a first plastic material into a flowable plastic melt, and two-dimensionally dispensing the plastic melt of the first plastic material in a first thickness using an extruder die or slot die;
applying a second scatterable and/or free-flowing plastic material in a defined two-dimensional way and in a defined pattern design using a pattern template to the plastic melt consisting of the first plastic material; and
calendaring or calibrating the thickness of the plastic melt and simultaneously at least partially impressing the second plastic material applied two-dimensionally and in a pattern design into the first plastic material by means of a calendar assembly;
cooling the melt into a solid plastic sheet.

2. The sheet production process according to claim 1, characterized in that a differently colored first plastic material is used as said second plastic material.

3. The sheet production process according to claim 1, characterized in that said application of the second plastic material to the plastic melt consists of the first plastic material is performed by scattering.

4. The sheet production process according to claim 1, characterized in that for applying the second plastic material, said second plastic material is in the form of granules, a powder, grit or mixture of particles, wherein the particle size of the second plastic material on average
corresponds to the final thickness of the plastic sheet, or
is thicker by a maximum of 50% and/or thinner, for a minimum of 70%, than the final thickness of the plastic sheet.

5. A sheet production assembly for producing a thermally deformable plastic sheet having an at least two-color design comprising:
an extruder with a slot die for producing and dispensing a flat flowable plastic melt of a first plastic material;
an application and/or scattering device for applying or scattering a second plastic material onto the plastic melt consisting of the first plastic material;
a calendar assembly for calibrating the thickness of the sheet and simultaneously at least partially impressing the second plastic material to the plastic melt consisting of the first plastic material;
wherein
said application and/or scattering device provided in the zone of the calendar assembly; and
the orientation of the plastic melt (1) in the zone of said application and/or scattering device (4) is horizontal.

6. The sheet production assembly according to claim 5, characterized in that said application and/or scattering device includes
a round template; and/or
a single or double doctor knife assembly.

7. The sheet production assembly according to claim 5, characterized in that said calendar assembly and said application and/or scattering device are combined, wherein the application and/or scattering device is arranged above a first calendar roll, and second roll and third calendar roll are provided in order to perform thickness calibration, wherein the second calendar roll and third calendar roll[s] are arranged above one another.

8. The sheet production assembly according to claim 5, characterized in that a transport belt assembly is provided behind said extruder die, wherein the extrusion is performed onto said transport belt assembly.

9. A thermally deformable plastic sheet having an at least two-color design comprising:
a first plastic material with a first color and at least one second plastic material with a second color different from the first color, wherein said plastic materials are molten together, the second plastic material is incorporated in the sheet at least partially, and by more than 30% of the sheet thickness in the thickness dimension, and at least one surface of the sheet has a defined design/pattern formed by said two-color design.

10. The sheet according to claim 9, characterized in that
said first and second plastic materials are made of the same material and have different colors, wherein said first and second plastic materials are selected from the materials:
olefin-based thermoplastic elastomers, TPU, TPE-O,
urethane-based thermoplastic elastomers, TPU, TPE-U, PVC,
a flexible thermoplastic material, polyethylene, polypropylene, polyvinyl chloride, polyurethane as such or as a component of copolymers, or in mixtures, unfilled as well as provided with an inorganic filler.

11. The sheet according to claim 9, characterized in that a material compatible with the first plastic material and having similar properties in the cold and heated states may also be employed as the second plastic material.
